(19) United States
(12) Patent Application Publication
(10) Pub. No.: US 2018/0000692 A1
(43) Pub. Date: Jan. 4, 2018

(54) Connected Pill Box

(71) Applicants: Lily A. Born, Lincolnwood, IL (US); Simon F. Greene, Lincolnwood, IL (US); Lisa Ghisolf, Lincolnwood, IL (US); Greg Baugues, Lincolnwood, IL (US); Joseph Born, Lincolnwood, IL (US)

(72) Inventors: Lily A. Born, Lincolnwood, IL (US); Simon F. Greene, Lincolnwood, IL (US); Lisa Ghisolf, Lincolnwood, IL (US); Greg Baugues, Lincolnwood, IL (US); Joseph Born, Lincolnwood, IL (US)

(73) Assignee: Imagiroo LLC, Lincolnwood, IL (US)

(21) Appl. No.: 15/613,191

(22) Filed: Jun. 3, 2017

Related U.S. Application Data
(60) Provisional application No. 62/345,187, filed on Jun. 3, 2016.

(51) Int. Cl. A61J 7/04; A61J 7/00; G01G 19/00

(52) U.S. Cl. CPC A61J 7/0418; A61J 7/0076; A61J 7/0069; G01G 19/00

(57) ABSTRACT

A smart pillbox with a basic weighing scale that provides an easy, accurate and robust mechanism to monitor the removal of pills using weight, without modifying the behavior of patients. When connected to a small, inexpensive computing device and clock/timing device, it can easily record the removal of pills. With the addition of a light, such as an LED, or a display, it can provide a visual notification as a reminder to take pills, as well as when pills were last taken. With the addition of a loudspeaker or other sound-generator, the notification can be audible with a variety of notification sounds or alarms that designate time pills should be taken.

This application is related to, and claims priority to, U.S. Provisional Patent Application No. 62/345,187 filed Jun. 3, 2016. Application 62/345,187 is hereby incorporated by reference in its entirety.

### BACKGROUND

### Field of the invention

The present invention relates generally to devices that hold medications such as pills and the like, and more particularly to a pill box that can keep track of pill weights to track taking of medications.

### Description of the Prior Art

There is considerable prior art related to devices that improve the pillbox. However, none of these provide a scale that provides weight information integrated into a conventional pill holder that allows easy delivery of pills and monitoring of pill consumption without requiring the user to perform onerous additional steps, or to operate a more complex or failure prone system. It would be advantageous to have a device that aides the user and/or caregiver in performing the existing pill consumption procedure and makes the process more failure resistant without adding additional complication to the user experience.

### SUMMARY OF THE INVENTION

The present invention relates to a pillbox with a basic weighing scale that provides an easy, accurate and robust mechanism to monitor the removal of pills using weight, without modifying the behavior of patients. When connected to a small, inexpensive computing device and clock/timing device, it can easily record the removal of pills. With the addition of a light, such as an LED, or a display, it can provide a visual notification as a reminder to take pills, as well as when pills were last taken. With the addition of a loudspeaker or other sound-generator, the notification can be audible with a variety of notification sounds or alarms that designate time pills should be taken. It can also notify patients and/or caregivers when removal is outside of a prescribed window. If the computing device is connected to the Internet and/or a remote computing device, remote notifications can be provided for the use of caregivers and/or health care providers.

It is an object of the invention to provide a pillbox with a fail safe mechanism that functions as a normal pillbox or jar/tray even if the electronics fail.

It is also an object of the present invention to assist the user and caregiver in the normal process of preparing and taking pills, and to not require them to undergo new, additional processes.

### DESCRIPTION OF THE FIGURES

Attention is now directed to several drawings the illustrate features of the present invention.

FIG. 1 shows a first embodiment of the present invention.

FIG. 2 shows a second embodiment of the present invention.

FIG. 3 shows the vertical configuration of the embodiment of FIG. 2.

FIG. 4 shows a third embodiment of the present invention.

FIG. 5 shows a fourth embodiment of the present invention.

FIG. 6 shows a fifth embodiment of the present invention.

Several figures and illustrations have been provided to aid in understanding the present invention. The scope of the present invention is not limited to what is shown in the figures.

### DESCRIPTION OF THE PREFERRED EMBODIMENTS

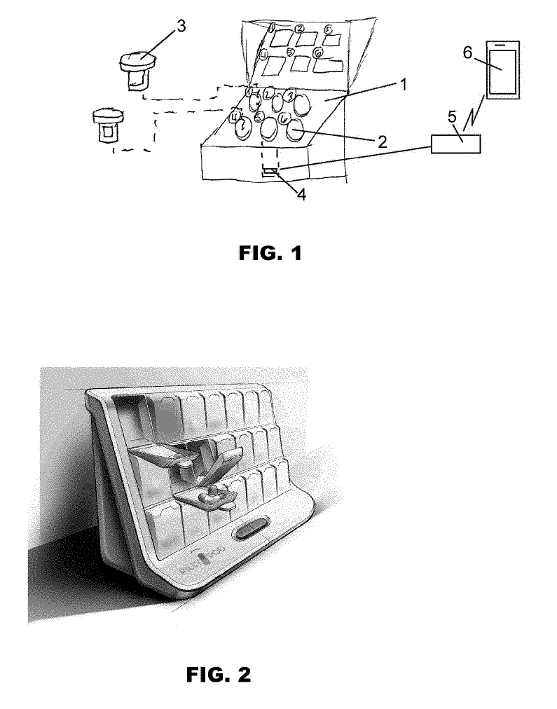

The First Embodiment of the present invention is shown in FIG. 1 and includes a tray 1 with a plurality of cavities 2 for holding a receptacle such as a pill jar 3 as commonly used to contain prescription medications as well as over the counter medication and/or vitamins or nutritional supplements. The cavities 2 are designed to accommodate existing pill jars provided by pharmacists and stores selling vitamins and such. As these jars vary in size, it is useful to have cavities of varying sizes, varying diameters and depths. At the base of each cavity is a scale 4 measuring the weight of each receptacle. Each scale is connected to a computing device 5, such as a microcontroller. The computing device can monitor multiple scales attached to the multiple cavities on a single tray. The computing device can also be connected to the Internet via a wired Ethernet connection or wirelessly (ie. Wifi). As an alternative, or in addition, the computing device could be connected to a smartphone 6, tablet or personal computer via a wired or wireless connection (such as bluetooth). It should be appreciated that the device could be either battery powered with a self contained battery or powered by wall power.

There are a variety of mechanisms that can be implemented to allow the tray to accurately gain information about the weight of individual pills. One mechanism is that the patient or caregiver is prompted through a guided calibration process upon the placement of a new pill jar into a receptacle. Such a process could be guided either visually with the use of a display either on the device itself or on a remote device such as a tablet, PC or smartphone. Such a process can also be guided by voice prompts if the device does not have a display, or if the patient or caregiver is visually impaired. Such a process can be initiated either because the user initiated the process, or because the device detects a new jar has been inserted into a receptacle. The device can detect the weight of a jar where one had not been previously, or that pills had been added to a pre-existing jar by detecting an increase in the weight of a jar, or that a partially or completely depleted jar had been replaced by a new jar. In the case of a new jar, the weight is recorded, and the user is prompted to remove a single pill, or multiple pills, from the jar and then replace the jar in the receptacle. The computing device can take the difference between the two weight measurements thereby arriving at the weight of the pill. Additionally, the user can be prompted for additional information such as the type of pills, which can be used to corroborate the weight of the pill. Alternatively, the user can be prompted to remove a second or multiple pills as a means to corroborate the accurate weight of the pill.

The monitoring of each jar is typically implemented by dedicating a receptacle to each jar of pills. The use of a label for each receptacle designating a medication is useful for this purpose. The embodiment shown in FIG. 1, uses a clip or label holding mechanism that allows storage of printed materials provided with the medication. Another mechanism is to provide a space for a user written label designating a location for each medication. Another possible mechanism is to illuminate the receptacle when the jar is removed, thus prompting the user to replace the jar into the illuminated receptacle when finished administering that jar's contents. An additional embodiment can provide audio cues that prompt the user to replace the jar into the designated receptacle. Such an audio prompt can be controlled by a timer that initiates an audio signal after a predetermined period after the jar's removal from the tray, thereby assisting the user in remember to replace the jar in the tray. In addition an audio queue could be used in the case that the user replaced the jar in a different receptacle. Such an audio queue could take the form of a buzzer or verbal prompt to notify the user that the jar had been placed into a different receptacle than it had been removed from.

Once the pill jar and pill weight is established by one of the above procedures for each receptacle and jar, the tray can monitor the removal of each pill/dosage. In the case of liquids, powdered medicine or supplements, rather than measuring the discrete number of pills, the tray can record the dosage in weight taken at a given time. The scale allows the distinction between the removal of a pill from a jar and the mere removal and replacement of a jar from the pill tray (as for example for the user to review the dosage instructions or to count the number of pills remaining.)

Removal of a pill jar can trigger an audible or visual prompt designating the dosage and last time that jar's contents was taken, for example “two pills taken at 2:37 pm May 3” which would provide an automatic way to gain information on pill consumption.

The invention can store a record of the time and date a pill or set of pills is consumed and can also upload that information to a remote computing device, which allows caregivers or medical practitioners access to this information. It may be desirable that in some cases, real time alerts be provided to caregivers if pill consumption falls outside of an acceptable window depending on the importance and sensitivity of a given medication. Such alerts can take the form of a smartphone notification, text message or automated phone call.

It should be appreciated that a single scale can be used to measure all the receptacles simultaneously instead of a scale dedicated to each individual receptacle. However dedicated scales for each cavity may be preferred in cases where it is desired to support certain use cases, for example, where multiple receptacles may be removed at once.

It is also useful to have a beveled edge at the top of the cavity to ensure the pill jar/lid can not get caught on the edge and affect the measurement of the receptacle. Also the upper edge of receptacle should be low enough such that the receptacle is accessible to allow easy access to the top of the jar for removal.

### Second Embodiment

In a second embodiment shown in FIG. 2, the pillbox has a vertical orientation when in use which has the benefit of taking less counter space and also by facilitating the removal of pills for consumption.

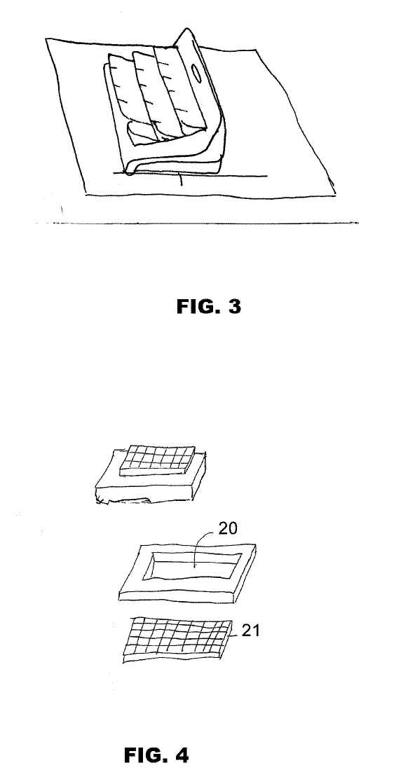

To fill the pillbox of this embodiment, the user places the pillbox in the horizontal position as shown in FIG. 3 with a scale on the back of the pillbox that gives the ability to measure the weight of the pillbox when it is in the horizontal position.

### Filling Procedure

There are at least two possible implementations of a guided filling procedure for the present invention. In the first, the device does not have pre-existing information about the weight of the pills such as a database of known pill weights. In this case, the following pill filling procedure can be followed:
1. User is prompted to input the name of pill and the quantity taken at a given time and an allowable range for pill consumption. For example one pill might be taken everyday sometime between 10 am and 1 pm, and the pillbox has 21 cavities with the cavities corresponding to 7 days and 3 times each day.
2. User is prompted to place the pills in the appropriate designated receptacles, in the above example, the seven middle sections designating mid-day would be marked to guide the user to those sections to be filled. Such a “waiting” designation or prompting can take the form of a verbal cue on screen display of a phone app. (which may include a visual representation of the array of receptacles on screen), or it may take the form of illuminating the appropriate receptacle section where the pill is to be placed.
3. In this embodiment, where the weight of the pill is not provided by an external source, if the pill is to be placed in a single receptacle, then the invention will not know the correct weight of the pill and can only validate based on the weight of the appropriate receptacle increasing by an amount within a range designated valid as the weight of a single pill; the range being between the lightest and heaviest pills anticipated being used.
4. If more than one receptacle is designated however, the app. can check the weight differential after the prompt, and a <positive designation> can be displayed (or audible) if the weight differentials are consistent among the appropriate receptacles. In other words, if, as in the above example, the user designates everyday, mid-day as the periods a given pill is to be taken, then if the weight of the seven middle receptacles increased by a consistent amount (with a variance range based on the natural manufacturing variance of the pills), the receptacles are deemed to have been filled correctly.
5. In the case where the above cue is an illuminated receptacle, a change of color (and or audible signal) can designate that the pill had been placed appropriately. That is, if the waiting designation was a white LED (used to designate receptacles awaiting the placement of the designated pill), that light could turn green and an affirming bell sound can be the “correct” designation providing user feedback that receptacle had received the appropriate pill. Alternatively, if a pill is placed in an incorrect receptacle section, or if a receptacle were overfilled, a red led can illuminate accompanied by a buzzer sound designating an error forming a “incorrect” designation.
6. Upon the successful completion of the filling of all cavities with all the needed medications, a signal designating filling completed indicates to the user to close all the cavity doors, and the user can then lift the pillbox to the vertical position. Once in the vertical position, a second scale, located on the bottom of the unit will engage with the supporting surface and thereby become able to measure the removal of pills while the pillbox remains in the vertical orientation.
   Filling Procedure with Known Pill Weights

If the above app. is enabled, for example, with a database of medications with weights associated with each of the medications, then the invention can check the weight incremented in each receptacle against that database and determine if the weight increment was within the known weight range (accounting for manufacturing and other variances) for that medication (and dosage). If it is correct, then the “correct” designation can be initiated, if it was not, then the “incorrect” designation can be initiated.

It should be appreciated that a variety of techniques can be used to establish the correct weight of pills, including the participation of the pharmacist, or medical practitioner in the process.

An additional benefit of this embodiment is that because of its vertical orientation, the user may be assisted by gravity in the removal of pills. The cavity lid in this embodiment can have a scoop-like shape with raised edges which captures pills that roll or slide out of the cavity. Although the lid may have raised edges which prevent the pills from accidentally sliding out of the lid and onto the table or floor, it is nonetheless significantly more shallow than the main cavity, thereby allowing easier access to the pills than by reaching into the cavity directly as is the case of a conventionally oriented horizontal pillbox.

### Third Embodiment

A third embodiment is shown in FIG. 4. In this embodiment, the pillbox is divided into two separate sections, the first is the base station 20 which contains the scale, processor, power supply and connection to the Internet or a separate computing device. The base station 20 also provides one or more cavities that hold a detachable set of receptacles to allow those receptacles to be weighed when placed into a base station.

A detachable set of receptacles 21 is an enclosure with a lid and body for containing a set of pills, and carried in a pocket or bag. The receptacle can have a marking that designates its reoccurring time of intended consumption, such as “Friday Morning” or the like. Such a set may have a plurality of individual receptacles either connected to each other or individual as shown in. In either case, each receptacle holds a set of pills intended to be consumed at a given time period. In the case of a 21 segment, 7 day set of receptacles, a designation might be “mid day, Friday,”; in the case of a 7 segment, 7 day set of receptacles, the designation could be “Friday.” As in the second embodiment, the user is prompted to fill the receptacles based on the intended timing of pill consumption (ie a pill is intended to be taken at midday everyday and therefore is placed in the 7 middle receptacles of a 21 receptacle set)

These smaller, lighter receptacles allow the user to take the pills away from the base station and their home for additional portability. Such receptacles can be disposable while still maintaining the benefit of assisted and monitored filling. While precise monitoring of pill consumption is not be possible if the pills are consumed with the receptacles removed from the base station, the base station can nonetheless monitor time of removal and replacement of the receptacles, thereby providing a known window of time when the pills were consumed.

A remote computer can work in conjunction with the receptacles and base station to provide notifications to the user or caregiver regarding pill consumptions. For example, the patient can receive a smartphone alert reminding them to consume the contents of “mid day, Friday's” contents.

### Fourth Embodiment

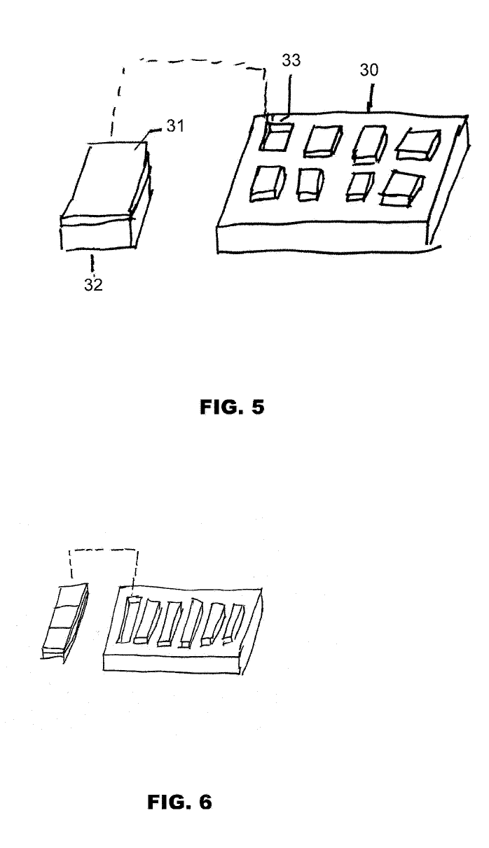

A fourth embodiment is shown in FIG. 5. This embodiment of the present invention includes a base station 30 and a plurality of detachable receptacles 31 as in the third embodiment. Unlike that embodiment however, instead of a set of scales to weigh the receptacles, the base station contains cavities 33 for receiving and electrically connecting to the detachable receptacles. These cavities allow connectivity to the receptacle through electrical contacts or similar techniques. In this embodiment, the detachable receptacles contain a weight sensing element 32 as well as a timer and battery to power the timer and weight sensing element in addition to an internal section which can contain a set of pills. It can also contain a lid which can be closed allowing the receptacle to be carried in a pocket, purse, briefcase, or the like and can have a contact switch, or similar element, that changes states when the lid is opened or closed. As in the third embodiment, such a detachable receptacle allows the user to carry this receptacle with them so as to be more accessible either during the day for example, when they are away from the home, or during the night when they might wish to keep the receptacle on the night stand for easier access. Because the receptacle has a scale and timer, it has the added benefit of being able to measure more precisely the time a medication is consumed. Although the detachable receptacles are typically not be able to communicate pill consumption in real-time to a remote computing device, they can nonetheless record the time of pill consumption and can communicate this information to the base station when replaced back in base station, thereby giving the patient, doctor or caregiver more precise information about when the pills were removed from the receptacle and taken. Separating the Internet connectivity from the receptacle allows the receptacle to be smaller and maintain a longer battery life.

As in the third embodiment, a remote computer can provide notification reminders to take a particular cavity's contents, also by virtue of its embedded timer and processor, such a detachable receptacle can also contain a notification mechanism such as a light and or loudspeaker which can notify users at the time to consume their medication

The invention of fourth embodiment typically requires a force sensing element in the receptacle itself. On the bottom of the receptacle are a set of feet, and the user is guided to place the receptacle on a flat, even surface. After the user takes some quantity of the pills and closes the receptacle, the user then places the receptacle on a stable, flat even surface. The weight sensing device in the receptacle, takes a measurement of the weight of the receptacle, and finding a stable measurement equal to or greater than the weight of the empty receptacle, and less than or equal to the weight of the full receptacle, records the new weight and time. Each time the receptacle is opened, this procedure is repeated. The receptacle can provide a “correct” designation feedback if the weight measurement is consistent with expected pills being removed.

### Fifth Embodiment

FIG. 6 shows a fifth embodiment of the invention. The fifth embodiment of the present invention builds on the fourth embodiment with a set of removable receptacles each with a plurality of separate sections each pertaining to a separate time period, for example “Friday: morning, noon, evening”. Such an embodiment has the advantage of using a single timer, processor and weight measuring mechanism for a plurality of sections rather than a single section.

### Features of All Embodiments

### Prompts

In all of the embodiments of the present invention disclosed herein, a series of prompts can assist the user in consuming their pills, such prompts include audio prompts as well as visual prompts. Such visual or audio prompts can come from the pillbox itself. For example, the appropriate cavity can be illuminated at the appropriate time to instruct the user to consume the pills in that cavity. Alternately, the alerts can come from the remote computer (for example an app. on a smartphone) which can notify the user which pill should be consumed from which cavity at that time). In addition, remote notifications can be sent to other remote computing devices if, for example, pill consumption falls outside of a designated window of compliance and a caregiver should be alerted to a potential danger for the patient

### Consumption Procedure

It is desirable to have a visual or audio signal designating the range of allowable pill consumption relative to the current time. One possible designation is a visual indicator showing “not yet time to take” “ready” and “overdue” as appropriate. It should be appreciated that such an indication can take a variety of forms such as a variety of visual or audio indications.

It should be noted that in those embodiments that require an application (app.), the app includes stored computer instructions that execute on a processor and are stored in at least one memory device. The processor can be in a smartphone, a tablet, a computer, or any other type of device including, in some cases, in the pillbox itself. Communication between the pillbox and an external device can be wireless using any wireless technology including, but not limited to, WiFi, Bluetooth™, Zigbee, cellular telephone or any other wireless or wired communication technique. The device running the app. can have a touchscreen, speaker, earphones, keypad (real or virtual) and all other interface components known in the art.

Several descriptions and illustrations have been presented to aid in understanding the present invention. One with skill in the art will realize that numerous changes and variations may be made without departing from the spirit of the invention. Each of these changes and variations is within the scope of the present invention.

We claim:

1. A pillbox apparatus that determines pill filling and consumption by using an internal scale to measure weight of each individual pill comprising:
a base station containing a plurality of cavities constructed to hold pill containers, said base station being in communication with a processor;
a scale in the base station configured to measure weight of a pill container inserted in one of the cavities and report said weight to the processor;
said processor executing stored instructions configured to sense by weight removal or addition of a single pill to a pill container in any of the plurality of cavities;
said processor also executing stored instructions that notify a user or healthcare provider that a particular pill has been added to or removed from a pill container in a particular cavity.

2. The pillbox apparatus of claim 1 wherein the base station is in communication with the Internet.

3. The pillbox apparatus of claim 1 wherein calibration of pill weight is accomplished by removal of one pill from a pill container.

4. The pillbox apparatus of claim 1 wherein notification is given to a user if a pill container is inserted into an incorrect cavity.

5. The pillbox apparatus of claim 1 wherein removal of a pill container from a cavity activates a user notification.

6. The pillbox apparatus of claim 1 wherein calibration uses a database of pill weights, the database stored in a memory device accessible by the processor.

7. The pillbox apparatus of claim 1 wherein the processor is in a smartphone or a tablet computer.

8. The pillbox apparatus of claim 1 wherein the stored instructions are an application (App) for a smartphone.

9. A smart pillbox comprising, in combination:
a base frame containing a fixed or removable receptacle, the receptacle containing at least one cavity constructed to receive and hold a pill bottle, the base frame being in communication with a processor;
a scale configured to weigh a pill bottle inserted into the cavity and sensitive enough to sense addition or removal of a single pill from the inserted pill bottle; and
wherein, the base station communicates the weight of the inserted pill bottle to the processor;
the processor executing stored computer instructions to determine from the weight of the inserted pill bottle a time and date when any pill is added to or removed;
the processor also executing stored computer instructions to notify a user or heathcare provider when a pill is added to or removed from the inserted pill bottle.

10. The smart pillbox of claim 9 wherein the user or healthcare provider is notified via the Internet.

11. The smart pillbox of claim 9 wherein the processor is in a smartphone or tablet computer.

12. The smart pillbox of claim 9 wherein the user is instructed to calibrate by inserting the pill bottle in the cavity, and then adding or removing a single pill from the pill bottle.

13. The smart pillbox of claim 9 wherein the scale is attached to the base frame.

14. The smart pillbox of claim 9 wherein the scale is attached to the receptacle.

15. The smart pillbox of claim 9 further comprising a second scale attached to the base frame, the second scale configured to measure weight of the base frame and receptacle.

16. A smart pillbox comprising:
a frame that includes a plurality of drawers, each drawer constructed to hold a plurality of pills, the frame having an upright vertical configuration for dispensing pills from the drawers and a flat horizontal configuration for load pills into the drawers;
a first scale attached to the frame constructed to weigh the frame in the upright vertical configuration;
a second scale attached to the frame constructed to weigh the frame in the flat horizontal configuration;
each of the first and second scales being sensitive enough to sense addition or removal of a single pill to a drawer;
a processor in communication with the frame, the processor receiving weight measures from the first and second scales;
the processor executing stored instructions using the weight measure from the first scale in the upright vertical configuration to sense dispensing of a single pill from a drawer, the processor notifying a user or healthcare provider of said dispensing of a pill;
the processor executing stored instructions using the weight measure from the second scale in the flat horizontal configuration to sense addition of a single pill to a drawer, the processor using said addition of a single pill to a drawer for calibration or for augmenting a count of pills in the smart pillbox.

17. The smart pillbox of claim 16, wherein the processor provides audio or visual instructions to a user during a pill loading process in said flat horizontal configuration.

18. The smart pillbox of claim 16 wherein the processor provides audio or visual instructions to a user while dispensing a pill in said upright vertical configuration.

19. The smart pillbox of claim 16, wherein the frame is in communication with the Internet.

20. The smart pillbox of claim 16 wherein the processor is a smartphone or tablet computer, and said communication is wireless.
